(19) United States
(12) Patent Application Publication
(10) Pub. No.: US 2012/0270067 A1
(43) Pub. Date: Oct. 25, 2012

(54) Method for Attaching Gold to Titanium and Niobium

(75) Inventors: Steven K. Boyd, Payson, AZ (US); Per A. Klype, Phoenix, AZ (US)

(73) Assignee: Medtronic, Inc.

(21) Appl. No.: 13/093,015

(22) Filed: Apr. 25, 2011

(51) Int. Cl. B32B 15/02; B23K 26/20

(52) U.S. Cl. 428/661; 219/121.64

(57) ABSTRACT

Gold can be attached to titanium or niobium using a laser having a wavelength that is reflected by gold but absorbed by titanium or niobium. The exemplified laser wavelengths are 1064 nm or 1080 nm.

### BACKGROUND

The disclosure relates generally to attaching gold to other metals such as titanium and niobium.

A wide variety of implantable medical devices (IMDs) that sense one or more parameters of a patient, deliver a therapy to the patient, or both have been clinically implanted or proposed for clinical implantation in patients. An IMD may deliver therapy to or monitor a physiological or biological condition with respect to a variety of organs, nerves, muscles, tissues or vasculatures of the patient, such as the heart, brain, stomach, spinal cord, pelvic floor, or the like. The therapy provided by the IMD may include electrical stimulation therapy, drug delivery therapy or the like.

Recent developments have provided such IMD's that are much smaller than traditional IMDs. For example, IMD's have been developed having a size such that the device can be deployed within the vasculature of a patient. However, the miniaturization of such devices may present challenges for their manufacture due to the small size of components used to manufacture such devices.

### SUMMARY

In one embodiment, the disclosure provides a method of attaching a first metal comprising gold to a second metal comprising titanium or niobium or both by using a laser beam having a wavelength that is reflected by the first metal comprising gold, but is absorbed by the second metal comprising titanium or niobium. In one embodiment, the wavelength of laser light or energy used is approximately 1064 nm or 1080 nm. In contrast, gold absorbs laser energy having a wavelength of about 532 nm and titanium and niobium reflects such a wavelength.

In another aspect, a tool is used to hold the metals in contact with one another during exposure to light energy having a wavelength of about 1064 nm or about 1080 nm.

In another embodiment, the disclosure provides an article comprising a first metal wire having a diameter of from 0.025 mm 0.152 mm comprising gold attached to a second metal comprising titanium or niobium and forming a connection joint, wherein the connection joint has an impedance of 0.1 Ohm or less. In one aspect, the first metal wire is attached to a circuit. In another aspect, the circuit is part of an implantable medical device. In another embodiment, the second metal wire is a feedthrough pin.

In another embodiment, the disclosure provides an article comprising a first metal wire having a diameter of from 0.025 mm 0.152 mm comprising gold attached to a second metal comprising titanium or niobium and forming a connection joint, wherein the connection joint has a length along the gold wire of from 0.051 mm to 0.203 mm.

### BRIEF DESCRIPTION OF THE DRAWINGS

FIG. 1 is a conceptual diagram illustrating an example medical system.

FIG. 2 illustrates an IMD implanted in a heart of a patient.

FIG. 3 is a depiction of a component of an implantable medical device.

FIG. 4 is a depiction of an embodiment of a tool used for attaching metals using a laser.

FIG. 5 is an enlarged depiction of a distal end of a tool used for attaching metals using a laser.

FIG. 6 is an enlarged depiction of a distal end of a tool used for attaching metals using a laser.

FIG. 7 is a depiction of a gold wire attached to a titanium wire using a method described in this application.

### DETAILED DESCRIPTION

As IMD's become smaller, attachment of various electrical components within such devices becomes challenging. Traditional methods of attaching metals such as direct welding, brazing and soldering are made difficult by the very small sizes of the connectors. Conductive adhesives can be used but their use can result in variable impedance which is unacceptable for circuits in such IMDs. The methods described in this application typically provide connection joints having an impedance of about 0.1 ohm or less.

In one embodiment, the disclosure provides a method of attaching a first metal comprising gold to a second metal comprising titanium or niobium or both by using a laser beam having a wavelength that is reflected by the first metal comprising gold, but is absorbed by the second metal comprising titanium or niobium. In one embodiment, the wavelength of laser light or energy used is approximately 1064 nm or 1080 nm. In contrast, gold absorbs laser energy having a wavelength of about 532 nm and titanium and niobium reflects such a wavelength. The methods of the invention do not include exposure of the first and second metals to wavelengths of laser beams of about 532 nm or wavelengths that are substantially absorbed by alloys of gold.

In one embodiment, to join or attach the first metal to the second metal, the first and second metals are placed into contact with one another, and the laser beam is focused on an area of the contacted first and second metals where attachment of the metals is desired. The laser beam wavelength is absorbed by the second metal which causes the second metal to heat to a temperature at or near the second metal's melting temperature about 1668° C. for TI and about 2477° C. for Nb. The heat from the second metal is transferred to the first metal through contact and causes the first metal to partially melt and become welded or attached to the second metal. The attachment of the metals using the methods described herein is meant to be robust and permanent for the intended use.

The first metals used in this method can be pure metals or may be metal alloys provided that the first metal at least substantially reflects the wavelengths of light used to heat the second metal. For example, alloys of gold and silver can be used in the methods described in this application. The second metal can be pure metal or can be metal alloys provided that the second metal at least substantially absorbs light having wavelengths of 1064 nm or 1080 nm or approximately 1064 nm or approximately 1080 nm. For example, alloys of titanium including those of grades 1 through grade 23 containing amounts of aluminum and vanadium and alloys of titanium and niobium can be used in the methods described in this application.

In another embodiment, the disclosure provides a method of attaching a first metal wire comprising gold to a second metal wire comprising titanium or niobium using a laser beam having a wavelength of approximately 1064 nm or 1080 nm. To join the wire comprising gold to the wire comprising titanium or niobium, the wires are placed in contact with one another, and the laser beam is focused on an area of the contacted wires where attachment of the wires is desired.

In one embodiment, the wire comprising gold and the wire comprising titanium or niobium are substantially perpendicular to one another when they are in contact with one another and the laser beam is focused on the contacted area. In general, the spot size of the laser beam is slightly larger than the diameter of the wire comprising gold. Typically, the spot size of the laser bean ranges from 0.002 (0.051 mm) to 0.008 inches (0.203 mm), and can be any size or range in between. The diameter of the spot size used relates to the length of the gold wire that is attached to the titanium or niobium that is the connection joint. In other words, the diameter of the spot size roughly equals the length of gold wire attached to the titanium or niobium below. The diameter of the first wire comprising gold can range from 0.001 inches (0.025 mm) to 0.006 inches (0.152 mm) and can be any diameter or range of diameters in between such range. The diameter of the second wire comprising titanium or niobium can range from 0.008 inches (0.203 mm) to 0.010 inches (0.254 mm) and can be any diameter or range of diameters in between such range.

In another embodiment, the disclosure provides a method of attaching a first metal wire comprising gold to a substrate comprising titanium or niobium using a laser beam having a wavelength of approximately 1064 nm or 1080 nm. The substrate could be for example, a housing or other metal component.

In one embodiment, a tool may be used to hold the first and second metal wires in contact during exposure to the laser beam. Desirably, the tool holds the first and second metals in intimate contact and substantially perpendicular and allows passage of the laser beam to the wires or metals in contact with one another. In other embodiments, a gold wire or a wire comprising gold connects electrical components to a titanium or niobium feedthrough wire and a gold wire connects to a ground wire which is connected to a titanium case of an IMD.

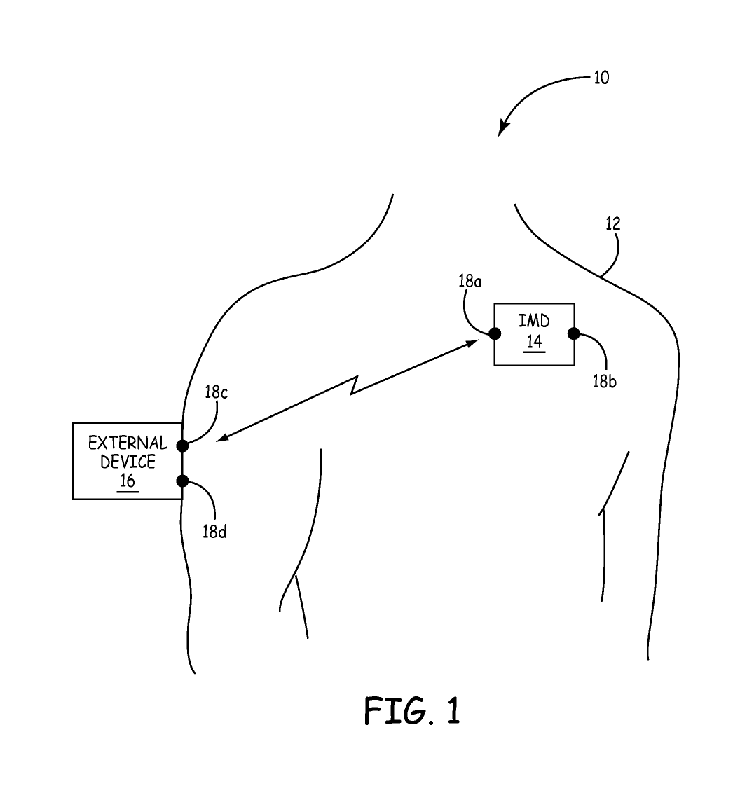

FIG. 1 is a conceptual diagram illustrating an example medical system 10. Medical system 10 includes an implantable medical device (IMD) 14 and an external device 16. Medical system 10 may, however, include more of fewer implanted or external devices.

IMD 14 may be any of a variety of medical devices that sense one or more parameters of patient 12, provide therapy to patient 12 or a combination thereof. In one example, IMD 14 may be a leadless IMD. In other words, IMD 14 is implanted at a targeted site with no leads extending from IMD 14, thus avoiding limitations associated with lead-based devices. Instead, sensing and/or therapy delivery components are integrated with IMD 14. In the case of a leadless sensor, IMD 14 includes one or more sensors that measure the physiological parameter(s) of patient 12. In one example, IMD 14 may comprise an implantable device incorporating a pressure sensor that is placed within a vasculature or chamber of a heart of patient 12.

IMD 14 may, in some instances, provide therapy to patient 12. IMD 14 may provide the therapy to patient 12 as a function of sensed parameters measured by the sensor of IMD 14 or sensed parameters received from another device, such as another IMD or a body worn device. As one example, IMD 14 may be a leadless cardiac IMD that provides electrical stimulation therapy (e.g., pacing, cardioversion, defibrillation, and/or cardiac resynchronization therapy) to the heart of patient 12 via one or more electrodes as a function of sensed parameters associated with the heart. In yet a further example, IMD 14 may provide therapy to patient 12 that is not provided as a function of the sensed parameters, such as in the context of neurostimulation. Although described above in the context of electrical stimulation therapy, IMD 14 may provide other therapies to patient 12, such as delivery of a drug or other therapeutic agent to patient 12 to reduce or eliminate the condition of the patient and/or one or more symptoms of the condition of the patient, or provide no therapy at all.

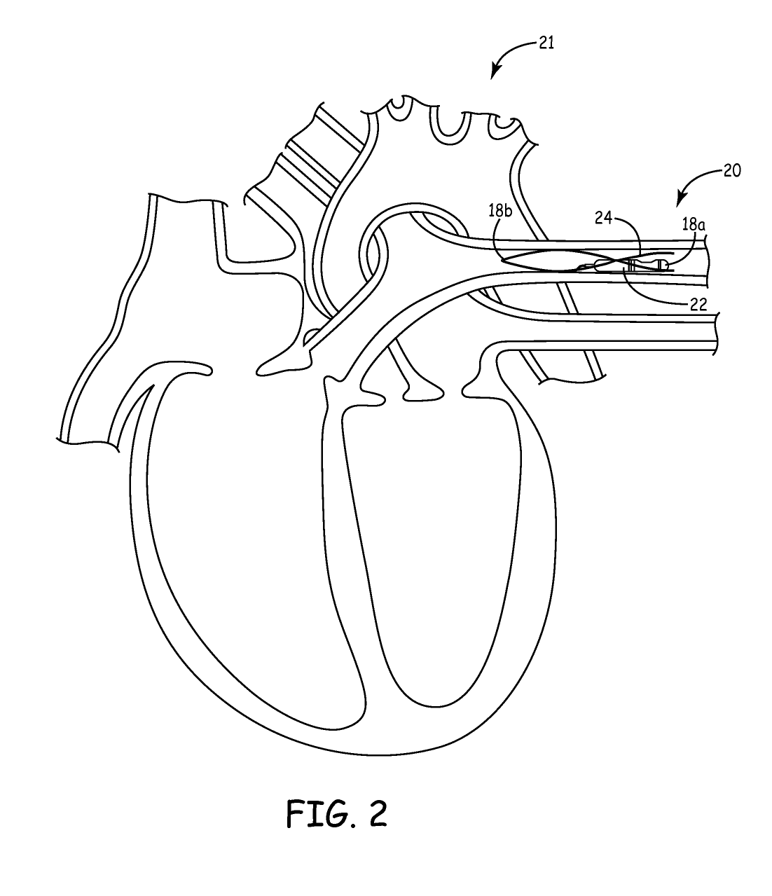

FIG. 2 is a schematic diagram illustrating an example IMD 20. IMD 20 may correspond with IMD 14 of FIG. 1. FIG. 2 illustrates IMD 20 implanted in a heart 21 of a patient 12. In the example illustrated in FIG. 2, IMD 20 is implanted in the pulmonary artery (PA) of heart 21. However, IMD 20 may be placed within or near other portions of heart 21, such as in one of the chambers (atrial or ventricular), veins, vessels, arteries or other vasculature of heart 21, such as the aorta, renal arteries, or inferior or superior vena cava.

IMD 20 includes a housing 22 and a fixation mechanism 24. Housing 22 and fixation mechanism 24 of IMD 20 may be sized and shaped to fit within a target location. In the example illustrated in FIG. 2, housing 22 has a long, thin cylindrical shape (e.g., capsule-like shape) to accommodate placement in the pulmonary artery of heart 21. Since IMD 20 may be placed within or near other portions of heart 21 or other locations within the body of patient 12, the size and shape of IMD 20 may vary based on the desired implant location. Additionally, the size and shape of housing 22 may vary depending on the number and type of sensors incorporated within housing 22. For example, housing 22 may be formed in a different shape to accommodate placement within a chamber of heart 21, along a spine, in a brain, or other location within or on patient 12.

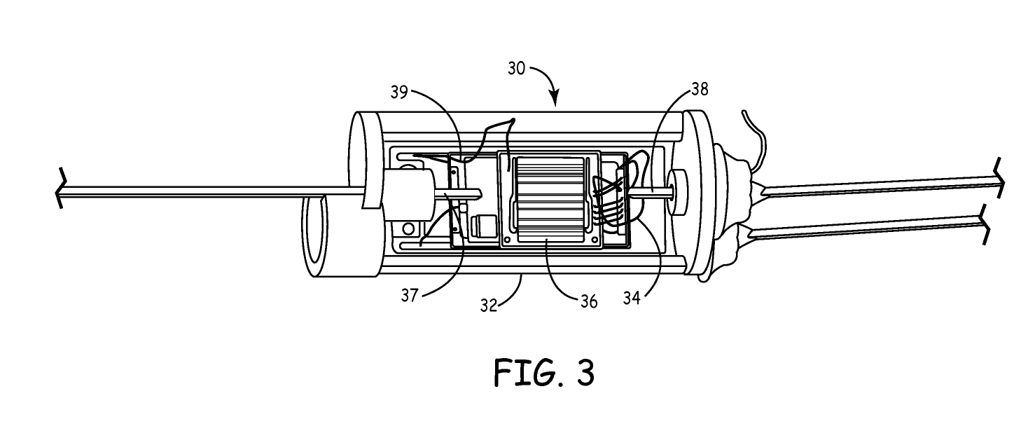

FIG. 3 is a depiction of a housing 32 of an IMD 32 that is open to show some internal components. In this example, gold wire 34 is attached to an integrated circuit 36 and is connected to titanium wire 38. The wires where attached via a laser beam as described in this application are substantially perpendicular. A second gold wire 39 is attached to a second titanium wire at a single point.

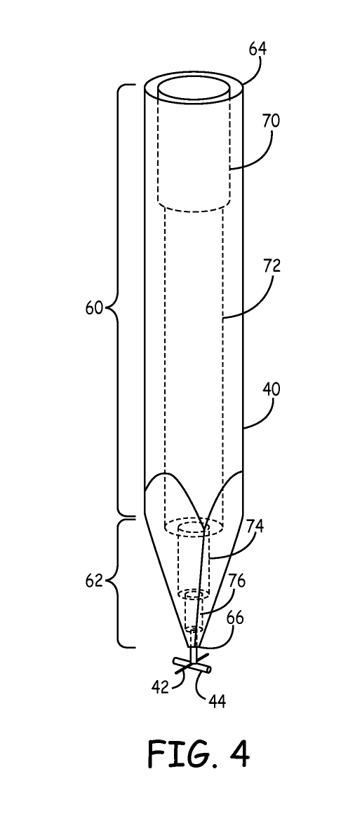

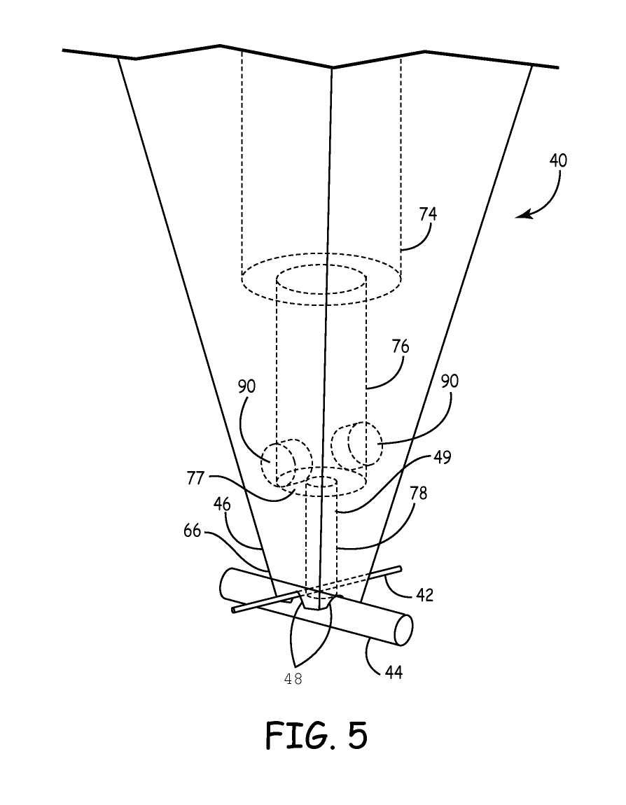

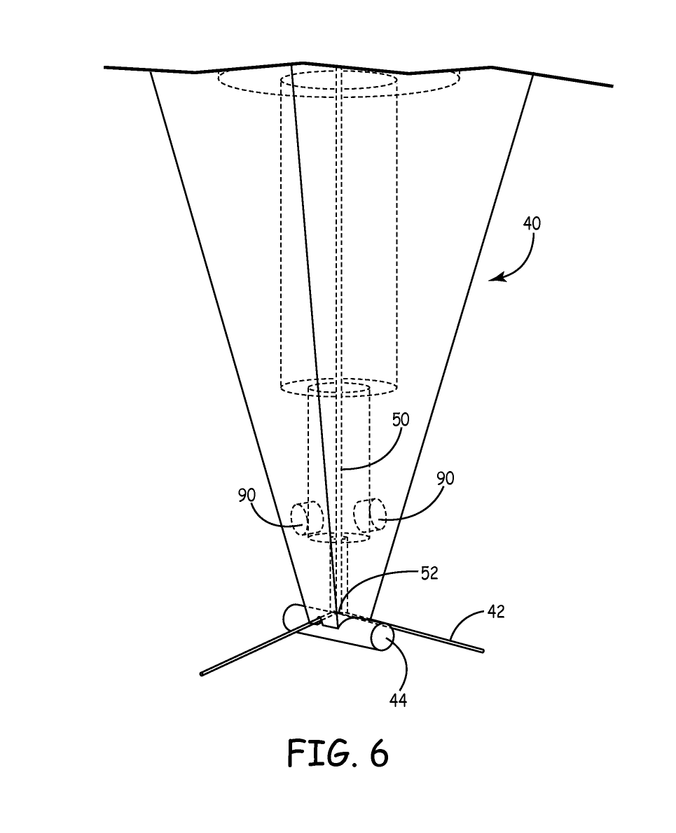

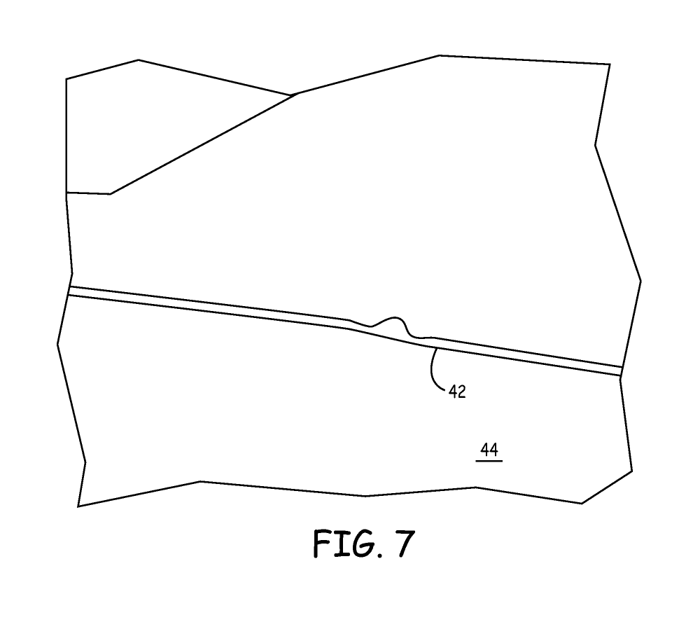

FIG. 4 is a depiction of a tool 40 that can be used with the laser bonding method described in this application. In this FIG. 4, the tool 40 is aligned with the contact area of the gold 42 and titanium 44 wires. FIG. 5 is a close-up of tool 40 engaged with the gold 42 and titanium 44 wires. The engagement end 46 of the tool has generally notches or grooves 48 which hold the wires in contact in the desired configuration. The tool has an internal passageway 49 that extends the length of the tool and is aligned with the area of the gold 42 and titanium 44 wires that overlap. The internal passageway 49 provides a path for the laser beam (not shown) from the laser (not shown) to the area of the gold and titanium wires that overlap and to be attached using a laser beam. FIG. 6 shows a laser beam 50 passing through the tool and forming a spot size 52 which is slightly larger than the diameter of the gold wire. The laser beam 50 is absorbed by the titanium wire 44 and heats the titanium wire 44 to a temperature at or near the melting point of titanium. The heat from the titanium wire is transferred to the gold wire 42 through contact and causes the gold wire to partially melt and become attached to the titanium wire. FIG. 7 is a depiction of an attachment of a gold wire 42 having a diameter of about 0.001 inches (0.025 mm) to a titanium wire 44 having a diameter of about 0.008 inches (0.203 mm). With a gold wire having such small diameters, Applicants have found that using wavelength of laser beam absorbed by gold, for example, about 532 nm would result in the gold wire rapidly melting or exploding and therefore no attachment to titanium or niobium.

Commercially available ytterbium lasers can be used in the methods described in this application. Useful lasers include those that are rated to provide 10 mJ to 20 mJ of power at either 1064 nm or 1080 nm, for example lasers available from Lasag, Buffalo Grove, Ill. USA. Typical pulse times for attaching metals, for example, 0.025 mm gold wire to titanium or niobium, ranges from 0.25 ms to 0.45 ms. The pulse time of the laser depends upon the diameter of wires being bonded, the metal or composition of the wires, wave length used, and power or delivered energy of the laser. In general, for attaching gold to titanium or niobium, the pulse time may range from 0.05 ms to 0.7 ms and may be any time or range of times between 0.05 ms and 0.7 ms.

Referring back to FIGS. 4, 5, and 6, the tool 40 is used to facilitate the cone shape of the laser beam and to hold the orientation of the metals or wires to be bonded in intimate contact while being attached using the methods described in this application. In the embodiment shown in FIGS. 4, 5 and 6, tool 40 has a cylindrical section 60 starting at the proximal end 64 and a conical section 62 terminating at the distal end 66 of the tool. Within an exemplary tool are five chambers, first chamber 70, second chamber 72, third chamber 74, fourth chamber 76, and fifth chamber 78. As shown in FIG. 5, near the distal end 77 of the fourth chamber 76 are vent holes 90. In the embodiment shown, the vent holes 90 are opposed to one another and connect to the fourth chamber 76 from the exterior surface of the tool. The vent holes 90 allow cover gas to swirl and then escape from the tool to create a flow of cover gas, for example, an inert gas such as argon out of the tool. The cover gas typically flows from the proximal end 64 to and out of the distal end 66 at a flow rate of about 10 standard cubic feet per hour (4.72 L/m). In other embodiments, the tool may have fewer or more chambers of varying volumes.

The tool can generally be made from tungsten carbide. Typically such a tool can be made using machine tools and electrical discharge machining (EDM). The dimensions of the tool depend upon the size of the metals, for example, gold, tantalum and niobium, to be attached. For example, for a spot size that ranges from 0.051 mm to 0.203 mm, an opening in the distal end of the tool can have a diameter of about 0.15 mm and an overall length of about 19 mm. In use, the laser beam is aligned to the center of the tool and the tool and the beam are aligned such that the proper spot size overlaps the metals to be attached, as described above. Wires are typically attached together while they are suspended in air.

Various examples have been described. These examples, however, should not be considered limiting of the techniques described in this disclosure. These and other examples are within the scope of the following claims.

What is claimed is:

1. A method for attaching a first metal comprising gold to a second metal comprising titanium or niobium comprising the steps of:
placing the first metal in contact with the second metal; and
exposing the first and second metals to a laser beam having a wavelength of approximately 1064 nm or approximately 1080 nm.

2. The method of claim 1 wherein the first and second metals are exposed to the laser beam with a spot size of from 0.051 mm to 0.203 mm.

3. The method of claim 1 wherein the first metal is a wire comprising gold.

4. The method of claim 1 wherein the second metal is a wire comprising titanium or niobium.

5. The method of claim 1 wherein the first and second metals are exposed to the laser beam for a time of from 0.05 ms to 0.7 ms.

6. The method of claim 3 wherein the wire has a diameter that ranges from 0.025 mm 0.152 mm.

7. The method of claim 4 wherein the wire has a diameter that ranges from 0.203 mm to 0.254 mm.

8. The method of claim 1 wherein the second metal is a titanium or niobium substrate.

9. The method of claim 1 further including the step of holding the first and second metals in contact using a tool during exposure of the first and second metals to the laser beam.

10. The method of claim 1 wherein the first metal is an alloy of gold.

11. The method of claim 1 including the step of aligning the laser beam through a tool before using the tool to hold the first and second metals in contact.

12. The method of claim 1 including using an inert cover gas during the step of exposing the first and second metals to a laser beam having a wavelength of approximately 1064 nm or approximately 1080 nm.

13. The method of claim 1 wherein the second metal is a housing for a medical device.

14. The method of claim 1 wherein the first and second metals are exposed to the laser beam for a time of from 0.25 ms to 0.45 ms.

15. The method of claim 1 wherein the first metal is a wire connected to a medical device.

16. An article comprising:
a first metal wire having a diameter of from 0.025 mm 0.152 mm comprising gold attached to a second metal comprising titanium or niobium and forming a connection joint, wherein the connection joint has an impedance of 0.1 Ohm or less.

17. An article comprising:
a first metal wire having a diameter of from 0.025 mm 0.152 mm comprising gold attached to a second metal comprising titanium or niobium and forming a connection joint, wherein the connection joint has a length along the gold wire of from 0.051 mm to 0.203 mm.
